(19) United States
(12) Patent Application Publication
(10) Pub. No.: US 2017/0337352 A1
(43) Pub. Date: Nov. 23, 2017

(54) CONFIDENTIAL INFORMATION OCCLUSION USING AUGMENTED REALITY

(71) Applicant: DAQRI, LLC, Los Angeles, CA (US)

(72) Inventor: Nicole Williams, Los Angeles, CA (US)

(21) Appl. No.: 15/162,081

(22) Filed: May 23, 2016

(51) Int. Cl. G06F 21/10; G06F 21/62; G06F 21/32; G06T 19/00; G06F 3/00

(52) U.S. Cl. CPC G06F 21/10; G06T 19/006; G06F 3/005; G06F 21/32; G06F 21/6245

(57) ABSTRACT

A device comprises a camera, a display, and a processor. The camera captures an image of a physical object. The device identifies the physical object based on the image of the physical object and determines that the physical object includes confidential content. The device displays an AR content in the display in response to determining that the physical object includes the confidential content. The AR content occludes only the confidential content.

### TECHNICAL FIELD

The subject matter disclosed herein generally relates to an augmented reality device. Specifically, the present disclosure addresses systems and methods for occlusion of confidential information.

### BACKGROUND

Documents with sensitive material are typically disclosed to specific individuals that meet predefined criteria. For example, top secret documents may be only viewed by individuals with top secret clearance. One solution to shield the top secret documents from other individuals is to redact sensitive material from the documents. However, the process of redacting sensitive information is time consuming and cumbersome. Furthermore, different levels of disclosure can result in different levels of redaction and thus can further complicate the process of preventing disclosure of material.

### BRIEF DESCRIPTION OF THE DRAWINGS

Some embodiments are illustrated by way of example and not limitation in the figures of the accompanying drawings.

FIG. 1 is a block diagram illustrating an example of a network suitable for an augmented reality occlusion device, according to some example embodiments.

FIG. 2 is a block diagram illustrating an example embodiment of an augmented reality occlusion device.

FIG. 3 is a block diagram illustrating examples of sensors.

FIG. 4 is a block diagram illustrating an example embodiment of an augmented reality occlusion application.

FIG. 5 is a block diagram illustrating an example embodiment of a server.

FIG. 6 is a block diagram illustrating an example embodiment of a context-based dataset.

FIG. 7 is a flowchart illustrating a method for an operation of an augmented reality occlusion application, according to an example embodiment.

FIG. 8 is a flowchart illustrating a method for an operation of an augmented reality occlusion application, according to another example embodiment.

FIG. 9 is a flowchart illustrating a method for an operation of an augmented reality occlusion application, according to another example embodiment.

FIG. 10 is a flowchart illustrating a method for an operation of an augmented reality occlusion application, according to another example embodiment.

FIG. 11 is a flowchart illustrating a method for an operation of an augmented reality occlusion application, according to another example embodiment.

FIG. 12 is an interaction diagram illustrating interactions between an augmented reality display device and a server for an augmented reality occlusion application, according to an example embodiment.

FIG. 13 is a block diagram illustrating an example of an occlusion configuration, according to an example embodiment.

FIG. 14A is a diagram illustrating an example of an operation of an augmented reality occlusion application, according to an example embodiment.

FIG. 14B is a diagram illustrating an example of an operation of an augmented reality occlusion application, according to another example embodiment.

FIG. 15A is a diagram illustrating an example of an operation of an augmented reality occlusion application, according to an example embodiment.

FIG. 15B is a diagram illustrating an example of an operation of an augmented reality occlusion application, according to another example embodiment.

FIG. 16 is a block diagram illustrating components of a machine, according to some example embodiments, able to read instructions from a machine-readable medium and perform any one or more of the methodologies discussed herein.

### DETAILED DESCRIPTION

Example methods and systems are directed to an augmented reality (AR) occlusion device. Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

In one example embodiment, an AR occlusion device comprises a camera, a display, and a processor. The camera captures an image of a physical object (e.g., a text or graphic document, a tool, a machine, a building). The AR occlusion device includes a camera that captures physical objects within a field of view of the user. For example, the camera captures images of documents on a desk when the user is looking at the desk. In another example, the camera captures images of factory machines while the user is walking down an aisle in a factory. In another example embodiment, the AR occlusion device detects the presence of the physical objects within a predefined distance of the user of the AR occlusion device. For example, the detection may be performed through wireless means such as Bluetooth, wifi, zigbee, and so forth.

The AR occlusion device identifies the physical object based on the image of the physical object and determines that the physical object includes confidential content (e.g., document is top secret). For example, the AR occlusion device identifies the physical objects within the field of view of the user or within a predefined distance of the user and determines a confidentiality level associated with the physical object. The confidentiality level may refer to a level of sensitivity associated with the physical object. For example, a document containing top secret content has a higher confidentiality level than a document containing public information. In another example, a prototype of a new product has higher confidentiality level than a publicly release version of a product. Therefore, physical objects can be associated with different confidentiality levels. It may be understood that the AR occlusion device may determine a confidentiality level associated with the physical objects in any suitable means including but not limited to a QR code associated with the confidentiality level.

The processor includes an AR occlusion application that determines that the physical object includes the confidential content and causes the AR occlusion device to display an AR content (e.g., blank area over the confidential content) in the display. The AR content occludes the confidential content (e.g., a user of the device cannot see the confidential content).

In another example embodiment, the AR occlusion device determines a confidentiality level of the confidential content (e.g., top secret, very sensitive, sensitive). The confidential level may vary within a range of confidential levels (e.g., level 1 is public information only, level 5 is top secret information). The AR occlusion device generates an occlusion configuration based on the confidentiality level of the confidential content. For example, a paragraph or text considered top secret may be occluded at all times. Another text considered sensitive may not be occluded or partially occluded. Portions of a document can be occluded based on their confidentiality level. The AR occlusion device generates AR content to occlude the confidential content based on its confidentiality level. For the purposes of the application the term “occlude” is intended to include obstructing, covering, the confidential content by making the confidential content unreadable, invisible, or missing from the user's perspective. For example, the confidential content may be blurred out, rendered blank, or replaced with other information.

In another example embodiment, the AR occlusion device identifies a user of the device (e.g., John) and determines a permission level associated with an identification of the user (e.g., John has top secret clearance). The AR occlusion device can identify the user via several means. For example, the AR occlusion device can authenticate the user based on biometric data (e.g., iris pattern, voice recognition), username and password, and so forth. The AR occlusion device then determines a permission level associated with the identified user. For example, an executive of a company may have access to more sensitive documents (e.g., a higher permission level) than a clerk of the company. Therefore, different individuals may have different permission levels based on their respective position in a company or predefined privileges based on other parameters (e.g., top secret clearance, member of a group).

The AR occlusion device then determines a confidentiality level of the confidential content and generates an occlusion configuration based on the confidentiality level of the confidential content exceeding the permission level of the user. For example, if a document contains top secret information (e.g., confidentiality level 5), and John has top secret clearance (e.g., permission level 5), the AR occlusion device will not occlude the top secret information. If Joe has a permission level of “sensitive document only” (e.g., permission level 2), the AR occlusion device will occlude the top secret information to Joe. The permission level may vary within a range of permission levels (e.g., level 1 is permission to access public information only, level 5 is permission to access up to top secret information). The AR occlusion device generates the AR content based on the permission level and the confidentiality level to occlude the physical object to the user of the AR occlusion device.

In another example embodiment, the AR occlusion device identifies a user of the AR occlusion device and determines a permission level associated with an identification of the user. The AR occlusion device determines a confidentiality level of the confidential content and generates an occlusion configuration based on the confidentiality level and the permission level. The occlusion configuration identifies a portion (e.g., an area or part of the physical object such as engine part of a machine) of the physical object to be occluded to the user. The AR occlusion device generates the AR content based on the occlusion configuration to occlude only the confidential content to the user while allowing the user to view the remaining portion of the physical object.

In another example embodiment, the AR occlusion device identifies a user of the device and determines a permission level associated with an identification of the user. The AR occlusion device determines that the confidential content includes a document and a confidentiality level associated with the document. The AR occlusion device generates an occlusion configuration based on the confidentiality level and the permission level. The occlusion configuration identifies a portion of the document to be occluded to the user. The AR occlusion device generates the AR content based on the occlusion configuration and occludes only the portion of the document to the user.

In another example embodiment, the AR occlusion device identifies a user of the device and determines a permission level associated with an identification of the user. The AR occlusion device generates a replacement content consistent with the permission level of the user. The AR content includes the replacement content. The replacement content occludes and replaces the confidential content. For example, the replacement content may be a public version of a paragraph. The AR occlusion device occludes the confidential content or paragraph of a document by displaying a replacement content (e.g., replacement paragraph) on top of the confidential content. For example, if a user were to look at a document having a paragraph containing sensitive or confidential material, the AR occlusion device would replace the paragraph containing sensitive or confidential material with the AR content. The AR content includes a replacement paragraph containing public information. Therefore, the user would perceive the replacement paragraph as part of the original document and may not notice the occlusion of the portion of the document containing sensitive or confidential material. Alternately, the AR content may include a blank space over the sensitive or confidential material.

In another example embodiment, the AR content includes a notification of the confidential content to a user of the device. For example, the AR content may include an exclamation or a warning icon on top of the confidential content. In another example, the AR content also includes a visual filter displayed on top of the confidential content to render the confidential content blurry to the user. For example, the AR content includes a three-dimensional or two-dimensional model of a virtual item to warn the user that the physical object or a part of the physical object has been occluded.

In another example embodiment, the AR content includes a portion of an image of a background of the physical object. For example, portions of the background image may be rendered over the physical object such that the physical object appears “invisible” to the user or blends into the background. For example, the AR occlusion device may be pointed towards several cars in a parking lot. One of the car is a prototype considered confidential. The AR occlusion device displays AR content over that particular car to make it “disappear.” In another example, if a user were to look at a row of machines A, B, and C, and machine B is to be occluded, the AR content is displayed so that the user only sees machine A and C. The user would see the same background image of machine A and C in lieu of machine B so that machine B would be invisible to the user. Thus, the user would think that only machines A and C are present since the machine B is occluded by the background image that seamlessly blends in with the image or view of machines A and C.

In another example embodiment, the AR occlusion application detects a removal of the display from a line of sight between an eye of the user and the confidential content. For example, the user removes the AR occlusion device from the head of the user. Once detected, the AR occlusion application generates a notification message to a server in response to detecting the removal. The notification message identifies the user and the confidential content of the physical object detected by the AR occlusion device. Other example embodiments include tracking an eye gaze of the user to determine whether the user is looking at the confidential content contained in the physical object. The eye gaze information can be used to determine where to display the AR content.

In another example embodiment, the AR occlusion device includes a first set of sensors and a second set of sensors. The first set of sensors generates user-based sensor data related to a user of the device. The second set of sensors generates ambient-based sensor data related to the device. The AR occlusion application determines a user-based context based on the user-based sensor data, and an ambient-based context based on the ambient-based sensor data. The AR occlusion application generates an occlusion configuration based on the user-based context and the ambient-based context and generates the AR content based on the occlusion configuration.

The first set of sensors measures data related to the user. For example, the first set of sensors measures a combination of a heart rate, a blood pressure, brain activity, and biometric data related to the user to generate the user-based sensor data. Examples of the first set of sensors include a heart rate sensor, a sweat sensor, and a biometric sensor. The biometric sensor may include, for example, an ocular camera attached to the transparent display and directed towards the eyes of the user. In another example, the biometric sensor includes electroencephalogram (EEG)/electrocardiogram (ECG) sensors disposed inside a perimeter of the helmet so that the EEG/ECG sensors connect to the forehead of the user when the helmet is worn. The biometric sensor generates biometric data based on, for example, the blood vessel pattern in the retina of an eye of the user, the structure pattern of the iris of an eye of the user, the brain wave pattern of the user, or a combination thereof. The processor authenticates the user based on the biometric data of the user of the AR occlusion device.

The second set of sensors measures at least one of a geographic location of the AR occlusion device, an orientation and position of the AR occlusion device, an ambient pressure, an ambient humidity level, and an ambient light level to generate the ambient-based sensor data. Examples of the second set of sensors include a camera, GPS sensor, an Inertial Measurement Unit (IMU), a location sensor, an audio sensor, a barometer, a humidity sensor, and an ambient light sensor.

The AR occlusion device determines a user-based context based on the user-based sensor data, and an ambient-based context based on the ambient-based sensor data. The user-based context identifies the user of the AR occlusion device (e.g., user is John, employee 123, senior technician), a state of mind of the user (e.g., John is nervous), and a physical state of the user (e.g., John is sweating and breathing heavily while staring at machine M). The ambient-based context identifies data related to a state of the AR occlusion device. For example, the ambient-based context identifies ambient data related to the location of the AR occlusion device. For example, the ambient data may identify a geographic location (e.g., AR occlusion device located at factory plant P), an elevation (e.g., AR occlusion device is located on the 3^{rd} floor of the factory plant P), ambient pressure (e.g., atmospheric pressure in a room where the AR occlusion device is located), ambient humidity level (e.g., AR occlusion device is located in a room with humidity level of 60%), ambient light level (e.g., ambient brightness of 200 lumen detected by the AR occlusion device), ambient noise level (e.g., noise level of 90 db detected by the AR occlusion device).

In one example embodiment, the processor generates the AR content based on a combination of the user-based context and the ambient-based context. For example, the AR content occludes machine M which may be associated with user-based context C1 (e.g., John is sweating heavily and heart rate is above a threshold), and ambient-based context C2 (e.g., AR occlusion device worn by John is located on the second floor of factory plant P, in front of machine M, and the ambient noise level exceeds a siren noise level).

In another example embodiment, the AR occlusion device identifies the physical object in an image captured with the camera, retrieves a three-dimensional model of an AR content based on the identified physical object, an identification of the user, user-based context, and ambient-based context. The AR occlusion device renders and display the three-dimensional model of the AR content in a transparent display lens of the AR occlusion device. The virtual object (AR content) is perceived as an overlay on the real world object.

The display surface of the AR occlusion device may be retracted inside a head-mounted device (e.g., helmet) and extended outside the head-mounted device to allow a user to view the display surface. The position of the display surface may be adjusted based on an eye level of the user. The display surface includes a display lens capable of displaying AR content. The helmet may include a computing device such as a hardware processor with an AR application that allows the user wearing the helmet to experience information, such as in the form of a virtual object such as a three-dimensional (3D) virtual object, overlaid on an image or a view of a physical object (e.g., a document, a prototype, or any material of sensitive nature) captured with a camera in the helmet. The helmet may include optical sensors. The physical object may include a visual reference (e.g., a recognized image, pattern, or object, or unknown objects) that the AR application can identify using predefined objects or machine vision. AR content is displayed in the display lens of the helmet to occlude the physical object of sensitive nature. The display lens may be transparent to allow the user see through the display lens. The display lens may be part of a visor or face shield of the helmet or may operate independently from the visor of the helmet. The AR content may be rendered locally at the helmet or at a server in communication with the helmet. In one example embodiment, the user of the helmet may navigate the AR content using audio and visual inputs captured at the helmet or other inputs from other devices, such as a wearable device. For example, the display lenses may extract or retract based on a voice command of the user, a gesture of the user, a position of a watch in communication with the helmet.

In another example embodiment, a non-transitory machine-readable storage device may store a set of instructions that, when executed by at least one processor, causes the at least one processor to perform the method operations discussed within the present disclosure.

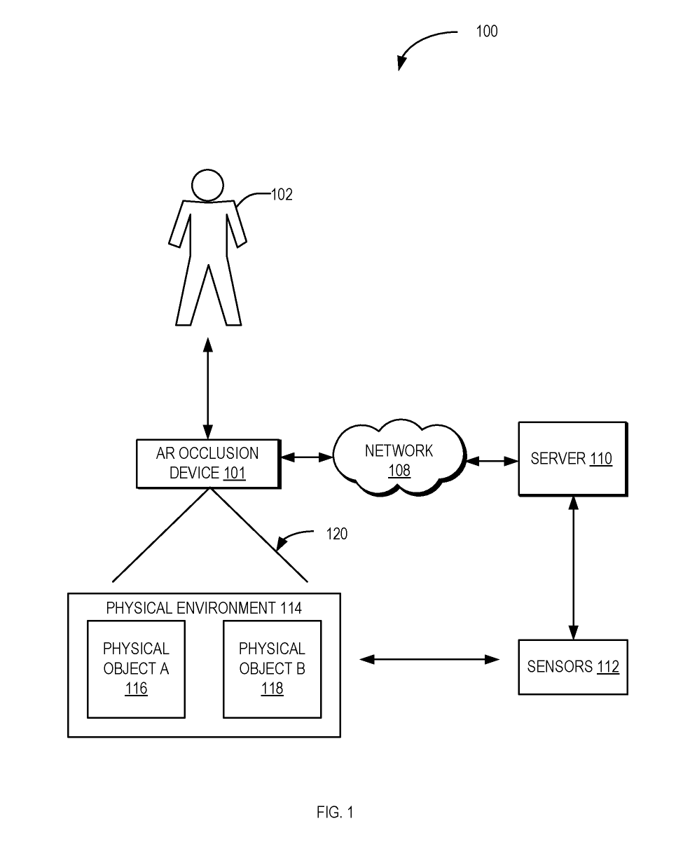

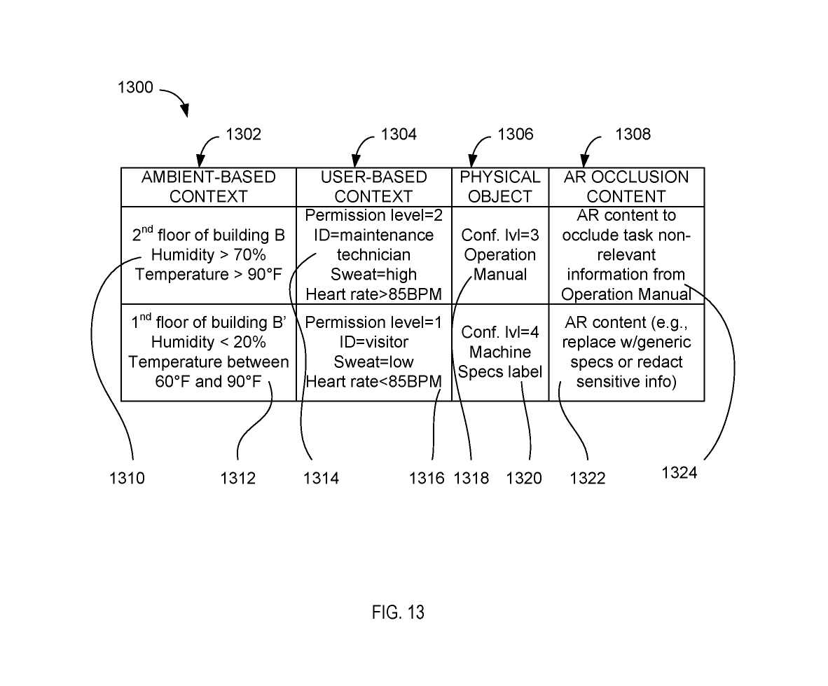

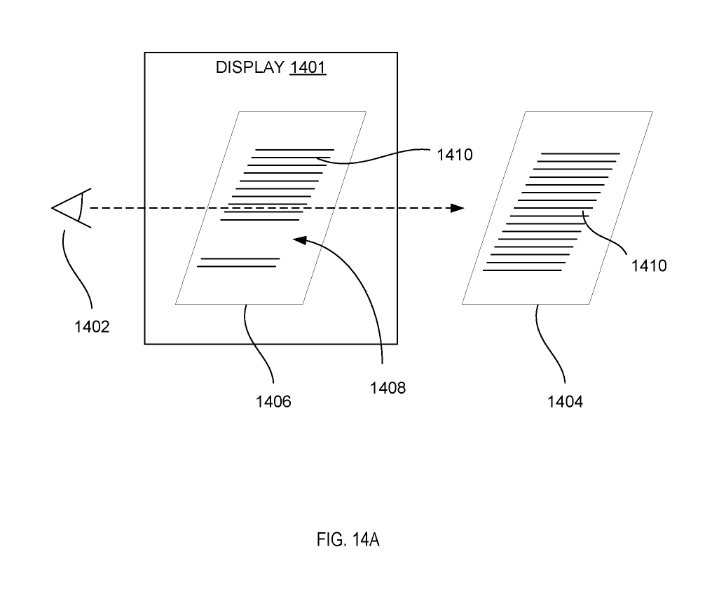

FIG. 1 is a network diagram illustrating a network environment 100 suitable for operating an AR occlusion device, according to some example embodiments. The network environment 100 includes an AR occlusion device 101 and a server 110, communicatively coupled to each other via a network 108. The AR occlusion device 101 and the server 110 may each be implemented in a computer system, in whole or in part, as described below with respect to FIG. 13.

The server 110 may be part of a network-based system. For example, the network-based system may be or include a cloud-based server system that provides AR content (e.g., occlusion content including augmented information including 3D models of virtual objects related to physical objects in images captured by the AR occlusion device 101) to the AR occlusion device 101.

The AR occlusion device 101 may include a head-mounted device (e.g., helmet) that a user 102 may wear to view the AR content related to captured images of several physical objects (e.g., physical object A 116, physical object B 118) in a real world physical environment 114. In one example embodiment, the AR occlusion device 101 includes a computing device with a camera and a display (e.g., smart glasses, smart helmet, smart visor). The computing device may be removably mounted to the head of the user 102. In one example, the display may be a screen that displays what is captured with a camera of the AR occlusion device 101. In another example, the display of the AR occlusion device 101 may be a transparent display, such as in the visor or face shield of a helmet, or a display lens distinct from the visor or face shield of the helmet.

The user 102 may be a user of an AR occlusion application in the AR occlusion device 101 and at the server 110. The user 102 may be a human user (e.g., a human being), a machine user (e.g., a computer configured by a software program to interact with the AR occlusion device 101), or any suitable combination thereof (e.g., a human assisted by a machine or a machine supervised by a human). The user 102 is not part of the network environment 100, but is associated with the AR occlusion device 101.

In one example embodiment, the AR occlusion application determines the AR content to be rendered and displayed in the transparent lenses of the AR occlusion device 101 based on sensor data related to the user 102 and sensor data related to the AR occlusion device 101. The sensor data related to the user 102 may include measurements of a heart rate, a blood pressure, brain activity, and biometric data related to the user. The sensor data related to the AR occlusion device 101 may include a geographic location of the AR occlusion device 101, an orientation and position of the AR occlusion device 101, an ambient pressure, an ambient humidity level, an ambient light level, and an ambient noise level detected by sensors in the AR occlusion device 101. The sensor data related to the user 102 may also be referred to as user-based sensor data. The sensor data related to the AR occlusion device 101 may be also referred to as ambient-based sensor data. For example, the AR occlusion device 101 may display a first AR content when the user 102 wearing the AR occlusion device 101 is on the first floor of a building. The AR occlusion device 101 may display a second AR content, different from the first AR content, when the user 102 is on the second floor of the building. In another example, the AR occlusion device 101 may display an AR content when the user 102 is alert and located in front of a confidential document in a basement. The AR occlusion device 101 may display a different AR content when the user 102 is inattentive and is located in front of the same confidential document. Therefore, different AR content may be displayed to the HMD 101 based on a combination of the user-based sensor data, the ambient-based sensor data, the confidential nature of a physical object (document), the level of permission or access of the user 102.

The physical environment 114 may include identifiable objects such as a 2D physical object (e.g., a picture), a 3D physical object (e.g., a factory machine), a location (e.g., at the bottom floor of a factory), or any references (e.g., perceived corners of walls or furniture) in the real world physical environment 114. The AR occlusion application includes computer vision recognition to determine corners, objects, lines, and letters. The user 102 may point a camera of the AR occlusion device 101 to capture an image of the physical objects A 116 and B 118 in the physical environment 114.

In one example embodiment, the physical objects A 116, B 118 in the image are tracked and recognized locally in the AR occlusion device 101 using a local context recognition dataset or any other previously stored dataset of the AR application of the AR occlusion device 101. The local context recognition dataset module may include a library of virtual objects associated with real-world physical objects A 116, B 118 or references. In one example, the AR occlusion device 101 identifies feature points in an image of the physical objects A 116, B 118 to determine different planes (e.g., edges, corners, surface, dial, letters). The AR occlusion device 101 may also identify tracking data related to the physical objects A 116, B 118 (e.g., GPS location of the AR occlusion device 101, orientation, distances to physical objects A 116, B 118). If the captured image is not recognized locally at the AR occlusion device 101, the AR occlusion device 101 can download additional information (e.g., occlusion configuration data) corresponding to the captured image, from a database of the server 110 over the network 108.

In another embodiment, the physical objects A 116, B 118 in the image are tracked and recognized remotely at the server 110 using a document dataset and occlusion configuration dataset or any other previously stored dataset of an AR occlusion application in the server 110. The occlusion configuration dataset may include a library of virtual objects or augmented information associated with real-world physical objects A 116, B 118 or references.

Sensors 112 may be associated with, coupled to, or related to the objects A 116 and B 118 in the physical environment 114 to measure a location, information, or captured readings from the physical objects A 116 and B 118. Examples of captured readings may include, but are not limited to, weight, pressure, temperature, velocity, direction, position, intrinsic and extrinsic properties, acceleration, and dimensions. For example, sensors 112 may be disposed throughout a factory floor to measure movement, pressure, orientation, and temperature. The server 110 can compute readings from data generated by the sensors 112.

The sensors 112 may include other sensors used to track the location, movement, and orientation of the AR occlusion device 101 externally without having to rely on the sensors 112 internal to the AR occlusion device 101. The sensors 112 may include optical sensors (e.g., depth-enabled 3D camera), wireless sensors (Bluetooth, Wi-Fi), GPS sensor, and audio sensors to determine the location of the user 102 having the AR occlusion device 101, a distance of the user 102 to the tracking sensors 112 in the physical environment 114 (e.g., sensors 112 placed in corners of a venue or a room), the orientation of the AR occlusion device 101 to track what the user 102 is looking at (e.g., direction at which the AR occlusion device 101 is pointed, AR occlusion device 101 pointed towards a prototype of a commercial product).

In another embodiment, data from the sensors 112 and internal sensors in the AR occlusion device 101 may be used for analytics data processing at the server 110 (or another server) for analysis on usage and how the user 102 is interacting with the physical environment 114. Live data from other servers may also be used in the analytics data processing. For example, the analytics data may track at what locations (e.g., points or features) on the physical or virtual object the user 102 has looked, how long the user 102 has looked at each location on the physical or virtual object, how the user 102 moved with the AR occlusion device 101 when looking at the physical or virtual object, which features of the virtual object the user 102 interacted with (e.g., such as whether a user 102 tapped on a link in the virtual object), and any suitable combination thereof. It is then possible to determine which confidential documents are most often looked at, or which portions of a document are most often looked at by different users and AR occlusion devices.

Any of the machines, databases, or devices shown in FIG. 1 may be implemented in a general-purpose computer modified (e.g., configured or programmed) by software to be a special-purpose computer to perform one or more of the functions described herein for that machine, database, or device. For example, a computer system able to implement any one or more of the methodologies described herein is discussed below with respect to FIG. 13. As used herein, a “database” is a data storage resource and may store data structured as a text file, a table, a spreadsheet, a relational database (e.g., an object-relational database), a triple store, a hierarchical data store, or any suitable combination thereof. Moreover, any two or more of the machines, databases, or devices illustrated in FIG. 1 may be combined into a single machine, and the functions described herein for any single machine, database, or device may be subdivided among multiple machines, databases, or devices.

The network 108 may be any network that enables communication between or among machines (e.g., server 110), databases, and devices (e.g., AR occlusion device 101). Accordingly, the network 108 may be a wired network, a wireless network (e.g., a mobile or cellular network), or any suitable combination thereof. The network 108 may include one or more portions that constitute a private network, a public network (e.g., the Internet), or any suitable combination thereof.

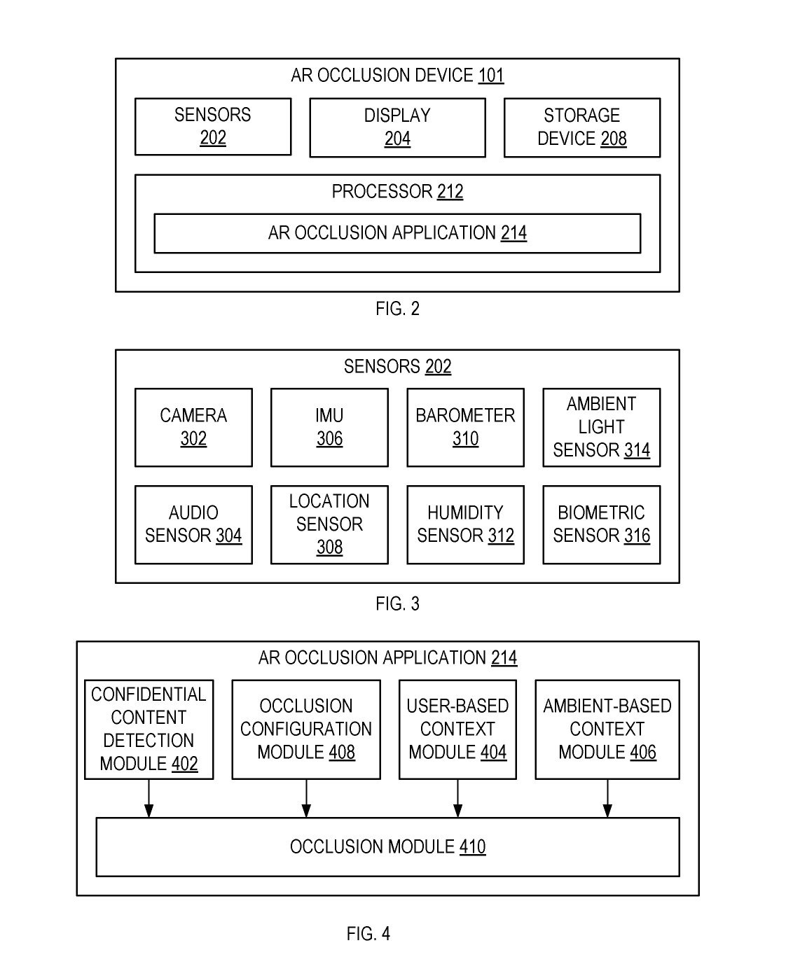

FIG. 2 is a block diagram illustrating modules (e.g., components) of the AR occlusion device 101, according to some example embodiments. The AR occlusion device 101 includes sensors 202, a display 204, a storage device 208, and a processor 212. The sensors 202 may be used to generate internal tracking data of the AR occlusion device 101 to determine a position and an orientation of the AR occlusion device 101. The position and the orientation of the AR occlusion device 101 may be used to identify real world objects in a field of view of the AR occlusion device 101. For example, a virtual object may be rendered and displayed in the display 204 when the sensors 202 indicate that the AR occlusion device 101 is oriented towards a real world object (e.g., when the user 102 looks at object A 116) or in a particular direction (e.g., when the user 102 tilts his head to watch his wrist). The AR occlusion device 101 may display a virtual object also based on a geographic location of the AR occlusion device 101. For example, virtual objects are displayed in the AR occlusion device 101 to occlude the user 102 when the user 102 is located within a predefined area (e.g., a specific room or building) associated with the sensitive material and the user is authenticated. Different levels of content of the virtual objects may be accessible based on a credential level of the user. For example, a user who is an executive of a company may have less occlusion than a manager at the same company. The sensors 202 may be used to authenticate the user prior to occluding the user from viewing sensitive material. Authentication may be achieved via a variety of methods such as providing a password or an authentication token, or using sensors 202 to determine biometric data unique to the user 102.

FIG. 3 is a block diagram illustrating examples of sensors 202 in the AR occlusion device 101. For example, the sensors 202 may include a camera 302, an audio sensor 304, an IMU sensor 306, a location sensor 308, a barometer 310, a humidity sensor 312, an ambient light sensor 314, and a biometric sensor 316. It is noted that the sensors 202 described herein are for illustration purposes. Sensors 202 are thus not limited to the ones described.

The camera 302 includes an optical sensor(s) (e.g., camera) that may encompass different spectrums. The camera 302 may include one or more external cameras aimed outside the AR occlusion device 101. For example, the external camera may include an infrared camera or a full-spectrum camera. The external camera may include a rear-facing camera and a front-facing camera disposed in the AR occlusion device 101. The front-facing camera may be used to capture a front field of view of the AR occlusion device 101 while the rear-facing camera may be used to capture a rear field of view of the AR occlusion device 101. The pictures captured with the front- and rear-facing cameras may be combined to recreate a 360-degree view of the physical world around the AR occlusion device 101.

The camera 302 may include one or more internal cameras aimed at the user 102. The internal camera may include an infrared (IR) camera configured to capture an image of a retina of the user 102. The IR camera may be used to perform a retinal scan to map unique patterns of the retina of the user 102. Blood vessels within the retina absorb light more readily than the surrounding tissue in the retina and therefore can be identified with IR lighting. The IR camera may cast a beam of IR light into the user's eye as the user 102 looks through the display 204 (e.g., lenses) towards virtual objects rendered in the display 204. The beam of IR light traces a path on the retina of the user 102. Because retinal blood vessels absorb more of the IR light than the rest of the eye, the amount of reflection varies during the retinal scan. The pattern of variations may be used as a biometric data unique to the user 102.

In another example embodiment, the internal camera may include an ocular camera configured to capture an image of an iris of the eye of the user 102. In response to the amount of light entering the eye, muscles attached to the iris expand or contract the aperture at the center of the iris, known as the pupil. The expansion and contraction of the pupil depends on the amount of ambient light. The ocular camera may use iris recognition as a method for biometric identification. The complex pattern on the iris of the eye of the user 102 is unique and can be used to identify the user 102. The ocular camera may cast infrared light to acquire images of detailed structures of the iris of the eye of the user 102. Biometric algorithms may be applied to the image of the detailed structures of the iris to identify the user 102.

In another example embodiment, the ocular camera includes an IR pupil dimension sensor that is pointed at an eye of the user 102 to measure the size of the pupil of the user 102. The IR pupil dimension sensor may sample the size of the pupil (e.g., using an IR camera) on a periodic basis or based on predefined triggered events (e.g., the user 102 walks into a different room, or there are sudden changes in the ambient light, or the like).

The audio sensor 304 may include a microphone. For example, the microphone may be used to record a voice command from the user 102 of the AR occlusion device 101. In other examples, the microphone may be used to measure ambient noise level to determine an intensity of background noise ambient to the AR occlusion device 101. In another example, the microphone may be used to capture ambient noise. Analytics may be applied to the captured ambient noise to identify specific types of noises such as explosions or gunshot noises.

The AR occlusion device sensor 306 may include an accelerometer, a gyroscope, and an inertial motion sensor to determine an orientation and movement of the AR occlusion device 101. For example, the AR occlusion device sensor 306 may measure the velocity, orientation, and gravitational forces on the AR occlusion device 101. The IMU sensor 306 may also detect a rate of acceleration using an accelerometer and changes in angular rotation using a gyroscope.

The location sensor 308 may determine a geolocation of the AR occlusion device 101 using a variety of techniques such as near field communication, GPS, Bluetooth, and Wi-Fi. For example, the location sensor 308 may generate geographic coordinates of the AR occlusion device 101.

The barometer 310 may measure atmospheric pressure differential to determine an altitude of the AR occlusion device 101. For example, the barometer 310 may be used to determine whether the AR occlusion device 101 is located on a first floor or a second floor of a building.

The humidity sensor 312 may determine a relative humidity level ambient to the AR occlusion device 101. For example, the humidity sensor 312 determines the humidity level of a room in which the AR occlusion device 101 is located.

The ambient light sensor 314 may determine an ambient light intensity around the AR occlusion device 101. For example, the ambient light sensor 314 measures the ambient light in a room in which the AR occlusion device 101 is located.

The biometric sensor 316 include sensors configured to measure biometric data unique to the user 102 of the AR occlusion device 101. In one example embodiment, the biometric sensors 316 includes an ocular camera, an EEG (electroencephalogram) sensor, and an ECG (electrocardiogram) sensor. It is noted that the descriptions of biometric sensors 316 disclosed herein are for illustration purposes. The biometric sensor 316 is thus not limited to any of the ones described.

The EEG sensor includes, for example, electrodes that, when in contact with the skin of the head of the user 102, measure electrical activity of the brain of the user 102. The EEG sensor may also measure the electrical activity and wave patterns through different bands of frequency (e.g., Delta, Theta, Alpha, Beta, Gamma, Mu). EEG signals may be used to authenticate a user based on fluctuation patterns unique to the user.

The ECG sensor includes, for example, electrodes that measure a heart rate of the user 102. In particular, the ECG may monitor and measure the cardiac rhythm of the user 102. A biometric algorithm is applied to the user 102 to identify and authenticate the user. In one example embodiment, the EEG sensor and ECG sensor may be combined into a same set of electrodes to measure both brain electrical activity and heart rate. The set of electrodes may be disposed around the helmet so that the set of electrodes comes into contact with the skin of the user 102 when the user 102 wears the AR occlusion device 101.

Referring back to FIG. 2, the display 204 may include a display surface or lens capable of displaying AR content (e.g., images, video) generated by the processor 212. The display 204 may be transparent so that the user 102 can see through the display 204 (e.g., such as in a head-up display).

The storage device 208 stores a library of AR content, reference ambient-based context, reference user-based context, reference physical objects, permission level of users, confidential level of the reference physical objects. The ambient-based context may identify ambient-based attributes associated with a corresponding AR content or application. For example, the ambient-based context may identify a predefined location, a humidity level range, a temperature range for the corresponding AR content. Therefore, ambient-based context “AC1” is identified and triggered when the AR occlusion device 101 is located at the predefined location, when the AR occlusion device 101 detects a humidity level within the humidity level range, and when the AR occlusion device detects a temperature within the temperature range.

The reference user-based context may identify user-based attributes associated with the corresponding AR content or application. For example, the user-based context may identify a state of mind of the user, physiological aspects of the user, reference biometric data, a user identification, and user privilege level. For example, user-based context “UC1” is identified and triggered when the AR occlusion device 101 detects that the user (e.g., user 102) is focused, not sweating, and is identified as a technician. The state of mind of the user 102 may be measured with EEG/ECG sensors connected to the user 102 to determine a level of attention of the user 102 (e.g., distracted or focused). The physiological aspects of the user 102 may include biometric data that was previously captured and associated with the user 102 during a configuration process. The reference biometric data may include a unique identifier based on the biometric data of the user 102. The user identification may include the name and tile of the user 102 (e.g., John Doe, VP of engineering). The user privilege level may identify which content the user 102 may have access to (e.g., permission level 5 means that the user 102 may have be occlusion-free for physical objects associated with level 5). Other tags or metadata may be used to identify the user privilege level (e.g., “classified”, “top secret”, “public”).

The storage device 208 may also store a database of identifiers of wearable devices capable of communicating with the AR occlusion device 101. In another embodiment, the database may also identify reference objects (visual references or images of objects) and corresponding AR content.

In one example embodiment, the AR occlusion device 101 may communicate over the network 108 with the server 110 to access a database of ambient-based context, user-based content context, reference objects, user permission level, confidential level of the reference objects, and AR content at the server 110. The AR occlusion device 101 then compares the ambient-based sensor data with attributes from the ambient-based context, and the ambient-based sensor data with attributes from the user-based context. The AR occlusion device 101 may also communicate with the server 110 to authenticate the user 102 and determine the level of access of the user, and the confidential level of the physical objects detected by the AR occlusion device 101.

The processor 212 may include an AR occlusion application 214. The AR application 214 detects and determiners whether a physical object or a portion of a physical object within a field of view of the AR occlusion device 101 and the user 102 is to be occluded. In one example embodiment, the AR occlusion application 214 generates AR content to occlude the detected physical object or a portion of the detected physical object. For example, the AR occlusion application 214 captures an image of object A 116 and recognizes that object A 116 should be occluded to the user 102 based on determining that object A 116 is confidential and should not be displayed to the user 102. The AR occlusion application 214 generates a display of an AR content that blocks out the image of object A 116 or a view of the object 116 from the user 102 perspective. For example, AR content is visually perceived as a layer on the object A 116.

In another example embodiment, the AR occlusion application 214 determines ambient-based context related to the AR occlusion device 101 and user-based context related to the user 102 and provide AR content based on a combination of the ambient-based context, the user-based context, the identification of object A 116, and an identification of the user 102. For example, the AR occlusion application 214 generates and displays a first AR content in the display 204 based a first combination of ambient-based context, user-based context, object identification, and user identification. The context-based application 216 provides a second AR content to the AR application 214 to display the second AR content in the display 204 based a second combination of ambient-based context, user-based context, object identification, and user identification.

FIG. 4 is a block diagram illustrating an example embodiment of the AR occlusion application 214. The AR occlusion application 214 is shown by way of example to include a confidential content detection module 402, a user-based context module 404, an ambient-based context module 406, and an occlusion configuration module 408.

The confidential content detection module 402 identifies the physical object 116. For example, the physical object 116 includes a document that includes confidential information. In another example, the confidential content detection module 402 identifies that the physical object 116 and 118 and determines that the physical object 116 is a prototype of a confidential nature and that physical object 118 is of a non-confidential nature (e.g., a chair). In one example embodiment, the confidential content detection module 402 detects the presence of the physical object 116, 118 and identifies the physical objects 116, 118 when present in a field of a view of the user 102 and the camera 302. The confidential content detection module 402 may use computer vision to recognize and identify the physical objects 116, 118.

The user-based context module 404 determines a user-based context based on user-based sensor data related to the user 102. For example, the user-based context module 404 identifies user-based context “UC1” based on user-based sensor data matching attributes including user-based sensor data ranges defined in a library in the storage device 208 or in the server 110. The ambient-based context module 406 determines an ambient-based context based on ambient-based sensor data related to the AR occlusion device 101. For example, the ambient-based context module 406 identifies ambient-based context “AC1” based on ambient-based sensor data matching attributes including ambient-based sensor data ranges defined in a library in the storage device 208 or in the server 110.

The occlusion configuration module 408 determines a physical object within a field of view of the user 102 is to be occluded or hidden from view of the user 102. For example, the occlusion configuration module 408 determines a confidentiality level of the physical object 116 (based on an identification of the physical object 116) and a permission level of the user 102 (based on an identification of the user 102). For example, the occlusion configuration module 408 determines that the physical object 116 is a confidential contract that the user 102 is not authorized to see.

The occlusion module 410 receives the identification of the physical object from the confidential content detection module 402, user-based context from the user-based context module 404, ambient-based context from the ambient-based context module 406, occlusion configuration from the occlusion configuration module 408 to generate AR content to occlude a physical object within a field of view of the user 102. For example, the occlusion module 410 generates AR content to prevent the user 102 from reading a sensitive portion of a document or to prevent the user from seeing a physical object among several objects. The AR content may be a plain colored virtual object to mask or block the physical object. In another example, the AR content may include a picture of the background to occlude the physical object so that the physical object would appear to be invisible. The AR content can include a replacement text displayed at the location of the sensitive portion of the document.

Any one or more of the modules described herein may be implemented using hardware (e.g., a processor 212 of a machine) or a combination of hardware and software. For example, any module described herein may configure a processor 212 to perform the operations described herein for that module. Moreover, any two or more of these modules may be combined into a single module, and the functions described herein for a single module may be subdivided among multiple modules. Furthermore, according to various example embodiments, modules described herein as being implemented within a single machine, database, or device may be distributed across multiple machines, databases, or devices.

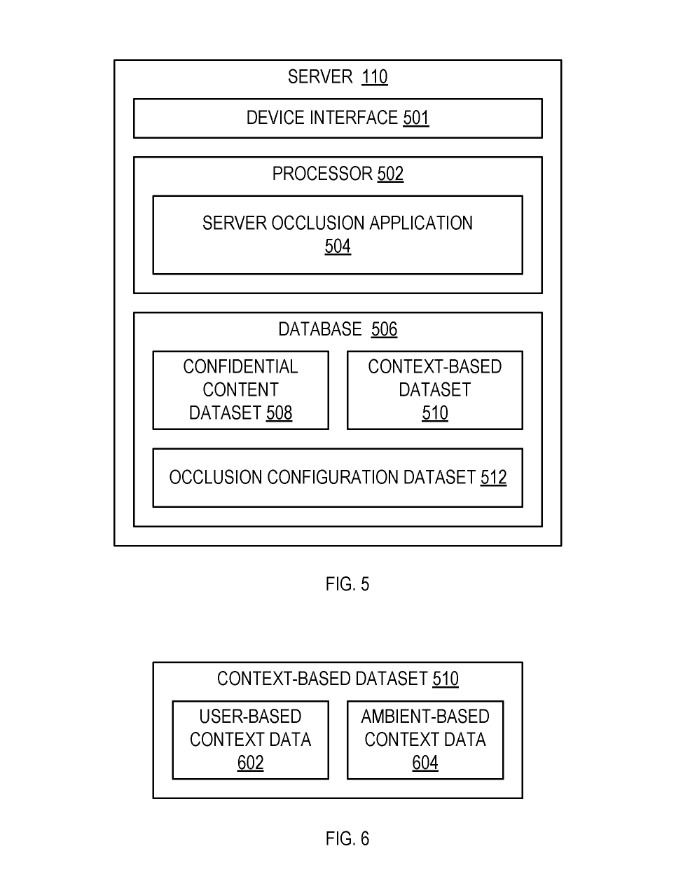

FIG. 5 is a block diagram illustrating modules (e.g., components) of the server 110. The server 110 includes a device interface 501, a processor 502, and a database 506. The device interface 501 communicates with the AR occlusion device 101, and sensors 112 (FIG. 1) to receive real time data.

The processor 502 may include a server occlusion application 504. The server occlusion application 504 identifies real world physical objects A 116, B 118 based on a picture or image frame received from the AR occlusion device 101. In another example, the AR occlusion device 101 has already identified objects A 116, B 118 and provides the identification information to the server occlusion application 504. AR content may be generated based on the real world physical object A 116 identified and a status of the real world physical object A 116.

The server occlusion application 504 receives an identification of the physical object 116, an identification of the user 102, an identification of user-based context, and ambient-based context from the AR occlusion device 101. In another example embodiment, the server occlusion application 504 receives user-based sensor data and ambient-based sensor data from the AR occlusion device 101. The server occlusion application 504 determines a confidential level of the physical object (e.g., top secret, public, employee only) and an permission level of the user 102 (e.g., top secret clearance, restricted information limited to documents related to project X). The server occlusion application 504 also compares the user-based context and ambient-based context received from the AR occlusion device 101 with user-based and ambient-based context in the database 508. The server occlusion application 504 determines whether the physical object 116 within a field of view of the user 102 is to be occluded based on the confidential level of the physical object 116, the permission level of the user the user-based sensor data, ambient-based sensor data.

If the server occlusion application 504 determines that physical object 116 is to be occluded or hidden, AR content is generated and displayed to only occlude the physical object 116 or a portion of the physical object 116. In another example, the server occlusion application 504 communicates the AR content to the AR occlusion device 101 to be rendered and displayed at the AR occlusion device 101. The AR occlusion device 101 tracks the physical object 116 and displays the AR content on top of the physical object 116.

The database 506 store a document dataset 508, a context-based dataset 510, and an occlusion configuration dataset 512. The document dataset 508 includes data related to identifications of physical objects and corresponding levels of confidentiality of users. For example, the context-based dataset 510 includes a library of user-based context data 602 and ambient-based context data 604 with an identification of the corresponding ranges for the user-based sensor data and ambient-based sensor data. The occlusion configuration dataset 512 includes data related to AR content generated for occlusion based on identifications of physical objects and corresponding levels of confidentiality of users, and context-based data.

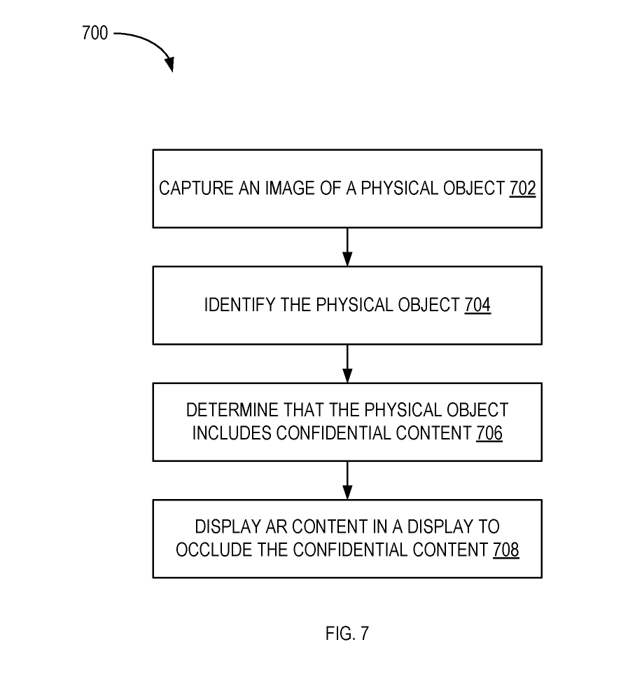

FIG. 7 is a flowchart illustrating a method 700 for occluding portions of a document using an AR occlusion device, according to an example embodiment. The method 700 may be deployed on the AR occlusion device 101 and, accordingly, is described merely by way of example with reference thereto. At operation 702, the AR occlusion device 101 captures an image of a physical object detected within a field of view of optical sensors in the AR occlusion device 101. At operation 704, the AR occlusion device 101 identifies the physical object based on the captured image of the physical object using for example, machine or computer vision techniques. At operation 706, the AR occlusion device 101 determines whether the physical object includes confidential content based on the identification of the physical object. Operations 702, 704, 706 may be implemented using the confidential content detection module 402 and occlusion configuration module 408. At operation 708, the AR occlusion device 101 displays AR content in a display to occlude the confidential content. Operation 708 may be implemented using the occlusion module 410.

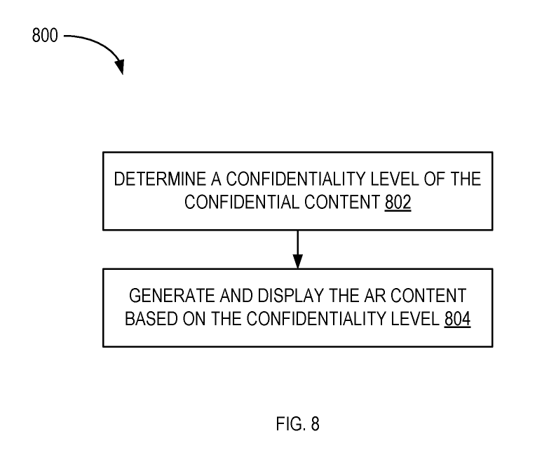

FIG. 8 is a flowchart illustrating a method for an operation of an augmented reality occlusion application, according to another example embodiment. The method 800 may be deployed on the AR occlusion device 101 and, accordingly, is described merely by way of example with reference thereto. At operation 802, the AR occlusion device 101 determines a confidentiality level of the confidential content based on an identification of the physical object. Operation 802 may be implemented using the confidential content detection module 402. At operation 804, the AR occlusion device 101 generates and displays the AR content based on the confidentiality level. Operation 804 may be implemented using the occlusion module 410.

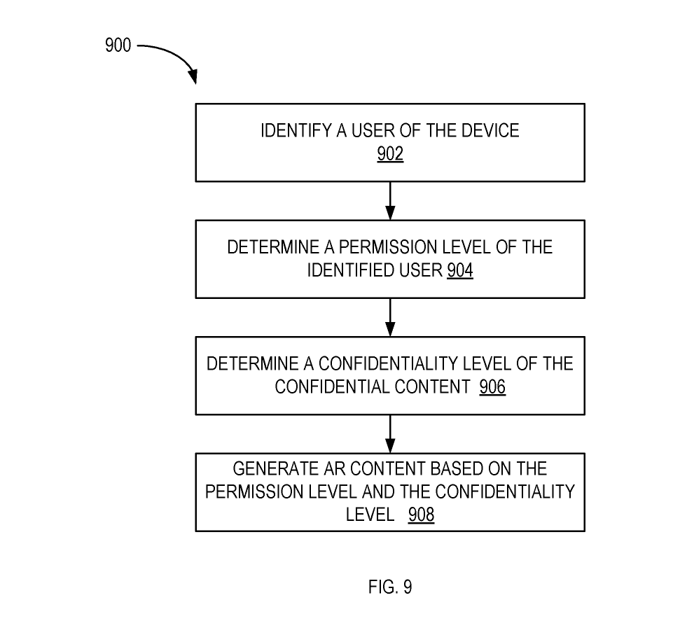

FIG. 9 is a flowchart illustrating a method for an operation of an augmented reality occlusion application, according to another example embodiment. The method 900 may be deployed on the AR occlusion device 101 and, accordingly, is described merely by way of example with reference thereto. At operation 902, the AR occlusion device 101 identifies a user of the AR occlusion device 101. At operation 904, the AR occlusion device 101 determines a permission level of the identified user based on the identification of the user. Operations 902, 904 may be implemented using the user-based context module 410. At operation 906, the AR occlusion device 101 determines a confidentiality level of the confidential content associated with the physical object. Operation 906 may be implemented using the confidential content detection module 402. At operation 908, the AR occlusion device 101 generates and displays the AR content based on the confidentiality level. Operation 908 may be implemented using the occlusion module 410.

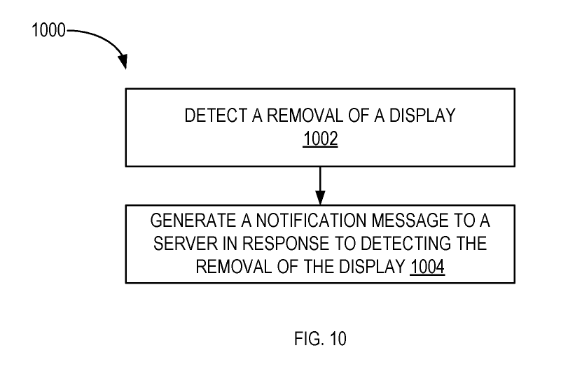

FIG. 10 is a flowchart illustrating a method for an operation of an augmented reality occlusion application, according to another example embodiment. The method 1000 may be deployed on the AR occlusion device 101 and, accordingly, is described merely by way of example with reference thereto. At operation 1002, the AR occlusion device 101 detects a removal of the display or the device itself off a head of the user. For example, the user may retract or a remove a visor including a display of the AR occlusion device 101. In another example, the user removed a head-mounted device from the user's head. The removal can be detected via various electrical or mechanical means. At operation 1004, the AR occlusion device 101 generates a notification message to a server in response to the removal detection. Operations 1002 and 1004 may be implemented using the AR occlusion application 214.

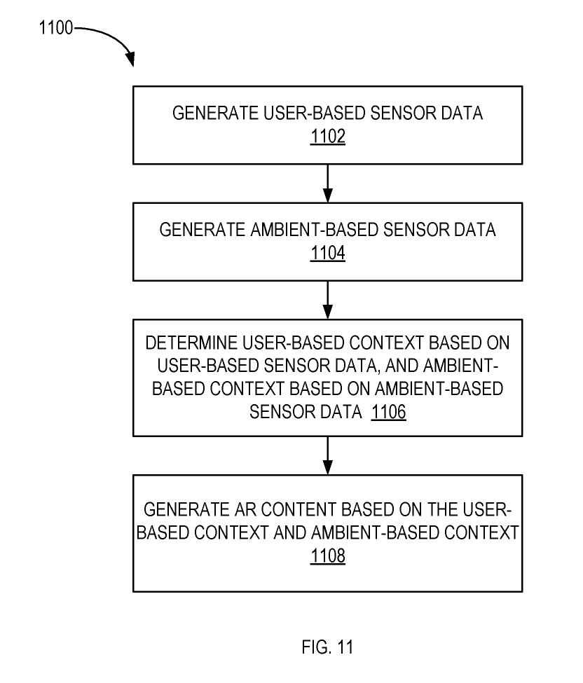

FIG. 11 is a flowchart illustrating a method for an operation of an augmented reality occlusion application, according to another example embodiment. The method 1100 may be deployed on the AR occlusion device 101 and, accordingly, is described merely by way of example with reference thereto. At operation 1102, the AR occlusion device 101 generates user-based sensor data. Operation 1102 may be implemented using the user-based context module 404. At operation 1104, the AR occlusion device 101 generates ambient-based sensor data. Operation 1104 may be implemented using the ambient-based context module 406. At operation 1106, the AR occlusion device 101 determines user-based context based on user-based sensor data, and ambient-based context based on ambient-based sensor data. Operation 1106 may be implemented using the user-based context module 404 and the ambient-based context module 406. At operation 1108, the AR occlusion device 101 generates AR content based on the user-based context and ambient-based context. Operation 1108 may be implemented using the occlusion module 410.

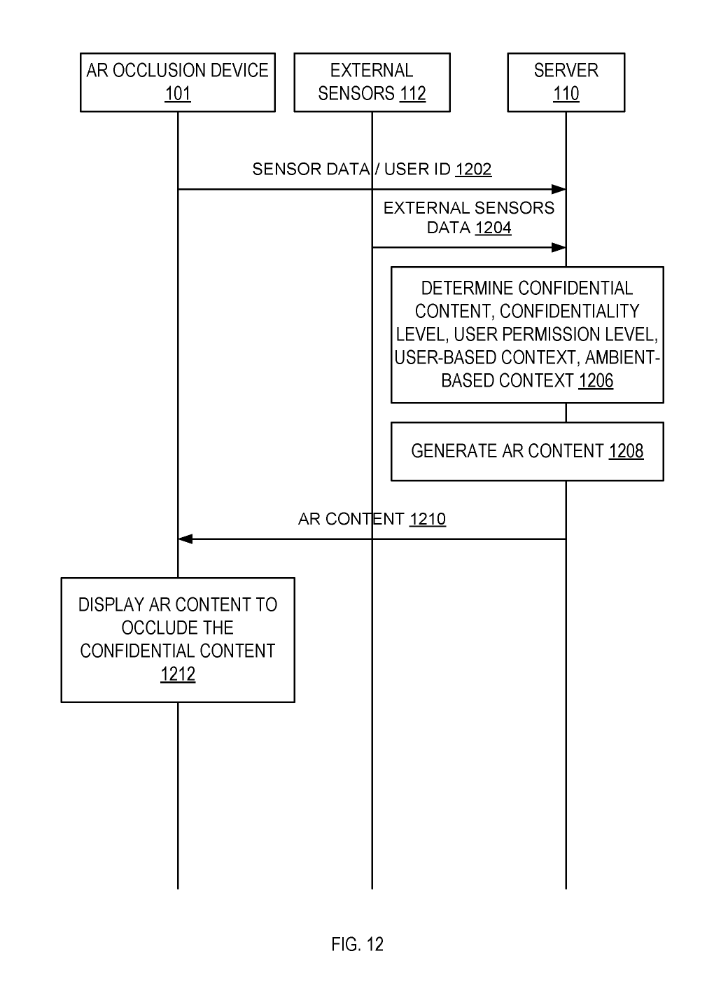

FIG. 12 is an interaction diagram illustrating interactions between an AR occlusion device and a server for occlusion, according to an example embodiment. The AR occlusion device 101 communicates with the server 110 via the network 108. At operation 1202, the AR occlusion device 101 provides display sensor data and user identification data to the user 101. At operation 1204, external sensors 112 provides external sensors data to the server 110. At operation 1206, the server 110 determines the confidential content, a confidentiality level, a user-permission level, a user-based context, and a ambient-based context. At operation 1208, the server 110 generates AR content based on the information determined at operation 1206. At operation 1210, the server 110 provides the AR content to the AR occlusion device 101. At operation 1212, the AR occlusion device 101 displays the AR content to occlude the confidential content.

FIG. 13 is a block diagram illustrating an example of an occlusion configuration 1300, according to an example embodiment. The occlusion configuration 1300 includes an ambient-based context 1302 related to the AR occlusion device 101, user-based context 1004 related to the user 102, identification of the physical object 1306, and AR occlusion content 1308. The ambient-based context 1302 may be defined with preconfigured ranges of ambient-sensor data. For example, a first ambient-based context 1310 is defined when the AR occlusion device 101 is located on the second floor of building B, with a humidity level greater than 70% and a temperature of at least 90° F. A second ambient-based context 1312 is defined when the AR occlusion device 101 is located on the first floor of building B′, with a humidity level less than 20% and a temperature of between 60° F. and 90° F.

The user-based context 1304 may also be defined with preconfigured ranges of user-sensor data. For example, a first user-based context 1314 is defined when the user 102 of AR occlusion device 101 is identified as a maintenance technician, the sweat level of the user 102 is high, and the heart rate of the user is greater than 85 bpm. A second user-based context 1316 is defined when the user 102 of AR occlusion device 101 is identified as a maintenance technician, the sweat level of the user 102 is low, and the heart rate of the user 102 is less than 85 bpm. The user-based context 1304 also identifies the permission level of a user. For example, the user in the first-user based context 1314 has a permission level “2.” The user in the second-user based context 1316 has a permission level “1.”

The AR occlusion device 101 may also identify physical objects 1306 associated with the ambient-based context 1302 and user-based context 1304. For example, the operation manual 1318 may be associated with the ambient-based context 1310 and the user-based context 1314. Similarly, the machine specifications label 1320 may be associated with the ambient-based context 1012 and user-based context 1016. The AR occlusion device also identifies confidentiality levels associated with the identified physical object. For example, the operation manual has a confidentiality level of “3.” The machine specifications label has a confidentiality level of “4.”

The AR occlusion device 101 also identifies AR occlusion content 1308 associated with the ambient-based context 1302, user-based context 1304, and physical object 1306. For example, AR content 1324 (e.g., AR content to occlude non-relevant task related information from the operation manual) may be associated with the ambient-based context 1310, the user-based context 1314, and the operation manual 1318. Similarly, AR content 1322 (e.g., AR content to occlude sensitive information and replace with generate information) may be associated with the ambient-based context 1312, the user-based context 1316, and the machine specs label 1320.

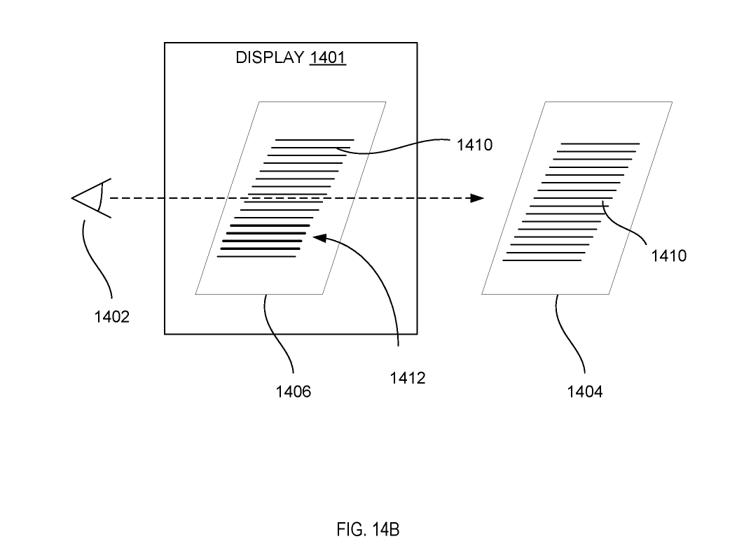

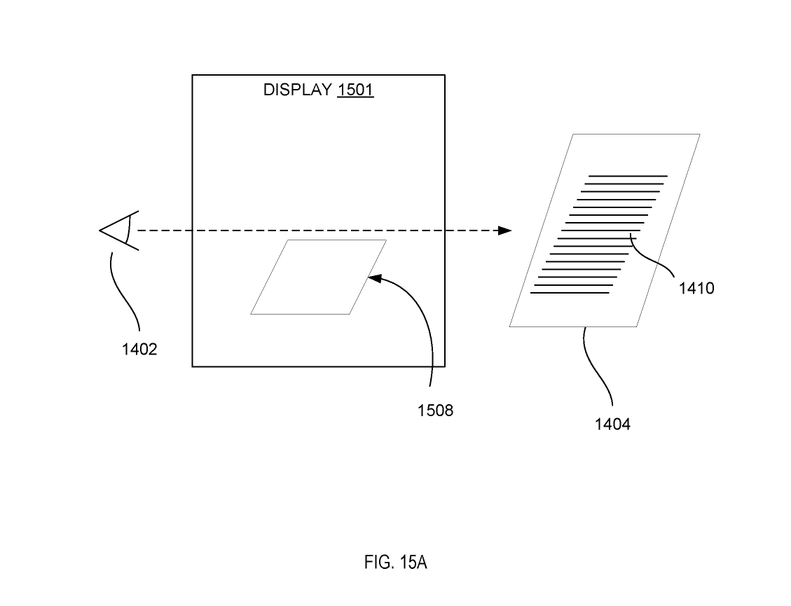

FIG. 14A is a diagram illustrating an example of an operation of an AR occlusion application, according to an example embodiment. An eye 1402 of the user 102 looks at a non-transparent display 1401. The display 1401 displays an image 1406 of the document 1404. For example, the document 1404 includes text 1410. The AR occlusion application determines that a portion of the text 1410 may confidential and is to be hidden from the user 102. AR content 1408 is displayed at the location corresponding to the sensitive or confidential portion of the document 1404. For example, the AR content 1408 appears to black out or blank out the sensitive or confidential corresponding portion of the document 1404.

FIG. 14B is a diagram illustrating an example of an operation of an AR occlusion application, according to another example embodiment. Instead of a black out or blank out content 1408 as illustrated in FIG. 14A, the AR content 1412 is displayed on top of the sensitive portion of the document 1404 and includes a replacement text. Therefore, the text 1404 and the replacement text are seamlessly combined and displayed in the display 1501 as one document to the eye 1402 of the user 102.

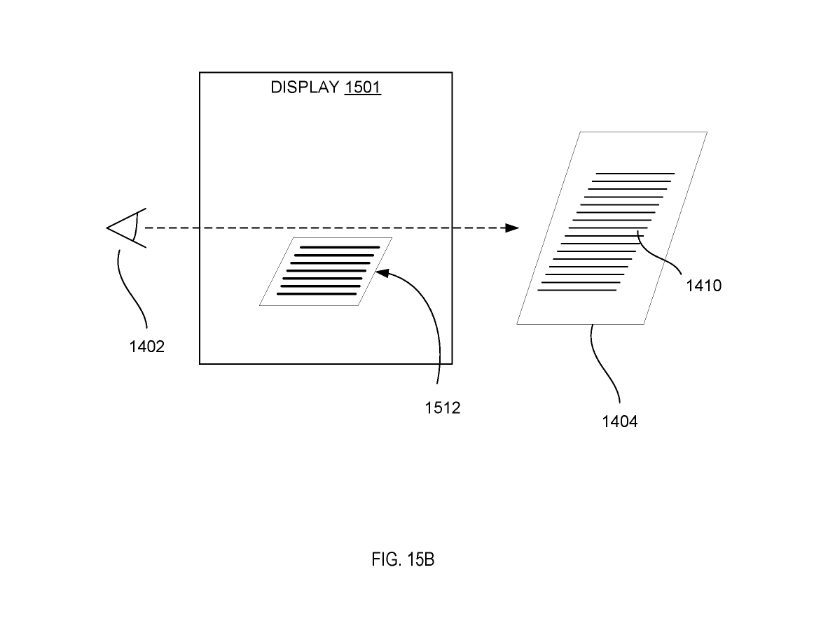

FIG. 15A is a diagram illustrating an example of an operation of an AR occlusion application, according to an example embodiment. An eye 1402 of the user 102 through a transparent display 1501 towards the document 1404 including text 1410. The AR occlusion application determines that a portion of the text 1410 may confidential and is to be hidden from the user 102. The transparent display 1501 displays AR content 1508 within a line of sight of the user 102 at the location corresponding to the sensitive or confidential portion of the document 1404. For example, the AR content 1508 appears to black out or blank out the sensitive or confidential corresponding portion of the document 1404.

FIG. 15B is a diagram illustrating an example of an operation of an AR occlusion application, according to another example embodiment. Instead of a black out or blank out content 1508 as illustrated in FIG. 15A, the transparent display 1501 displays the AR content 1512 within a line of sight of the user 102 so as to appear on top of the sensitive portion of the document 1404. The AR content 1512 includes a replacement text. Therefore, the user 102 sees the text 1410 and the replacement text of the AR content 1512 as seamlessly combined into one document.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor 212 or a group of processors 212) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor 212 or other programmable processor 212) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor 212 configured using software, the general-purpose processor 212 may be configured as respective different hardware modules at different times. Software may accordingly configure a processor 212, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors 212 that are temporarily configured (e.g., by software) or permanently configured to perform the relevant operations. Whether temporarily or permanently configured, such processors 212 may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors 212 or processor-implemented modules. The performance of certain of the operations may be distributed among the one or more processors 212, not only residing within a single machine, but deployed across a number of machines. In some example embodiments, the processor or processors 212 may be located in a single location (e.g., within a home environment, an office environment or as a server farm), while in other embodiments the processors 212 may be distributed across a number of locations.

The one or more processors 212 may also operate to support performance of the relevant operations in a “cloud computing” environment or as a “software as a service” (SaaS). For example, at least some of the operations may be performed by a group of computers (as examples of machines including processors 212), these operations being accessible via a network 108 and via one or more appropriate interfaces (e.g., APIs).

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor 212, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 108.

In example embodiments, operations may be performed by one or more programmable processors 212 executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers 110. A client and server 110 are generally remote from each other and typically interact through a communication network 108. The relationship of client and server 110 arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor 212), or a combination of permanently and temporarily configured hardware may be a design choice. Below are set out hardware (e.g., machine) and software architectures that may be deployed, in various example embodiments.

### Example Machine Architecture and Machine-Readable Medium

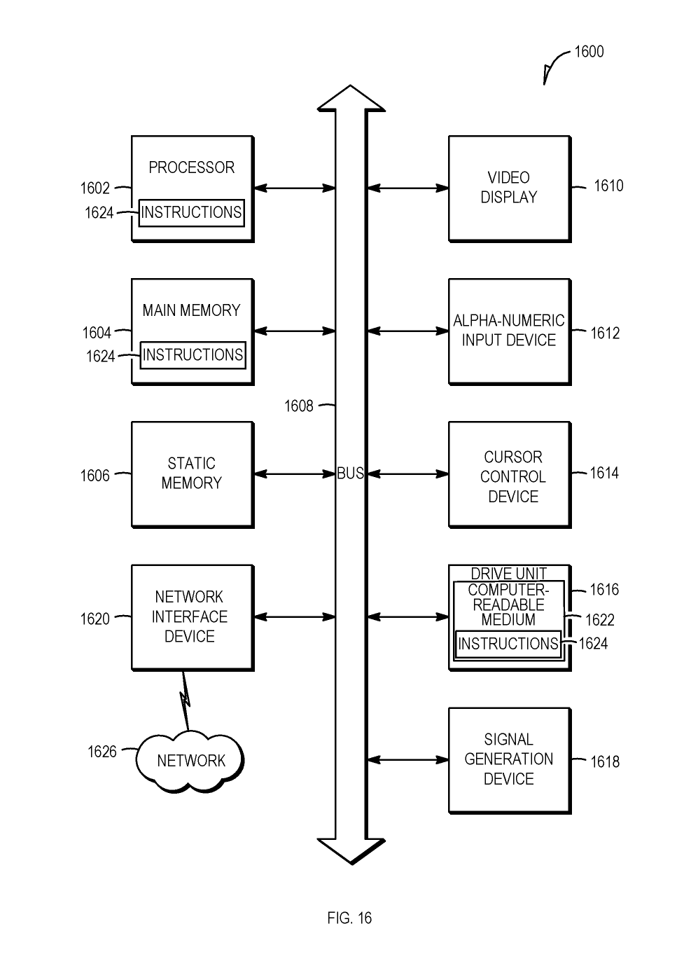

FIG. 16 is a block diagram of a machine in the example form of a computer system 1600 within which instructions 1624 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server 110 or a client machine in a server-client network environment, or as a peer machine in a peer-to-peer (or distributed) network environment. The machine may be a computing device or any machine capable of executing instructions 1624 (sequential or otherwise) that specify actions to be taken by that machine. Further, while only a single machine is illustrated, the term “machine” shall also be taken to include any collection of machines that individually or jointly execute a set (or multiple sets) of instructions 1624 to perform any one or more of the methodologies discussed herein.

The example computer system 1600 includes a processor 1602 (e.g., a central processing unit (CPU), a graphics processing unit (GPU) or both), a main memory 1604 and a static memory 1606, which communicate with each other via a bus 1608. The computer system 1600 may further include a video display unit 1610 (e.g., a liquid crystal display (LCD) or a cathode ray tube (CRT)). The computer system 1600 also includes an alphanumeric input device 1612 (e.g., a keyboard), a user interface (UI) navigation (or cursor control) device 1614 (e.g., a mouse), a disk drive unit 1616, a signal generation device 1618 (e.g., a speaker) and a network interface device 1620.

### Machine-Readable Medium

The disk drive unit 1616 includes a computer-readable medium 1622 on which is stored one or more sets of data structures and instructions 1624 (e.g., software) embodying or utilized by any one or more of the methodologies or functions described herein. The instructions 1624 may also reside, completely or at least partially, within the main memory 1604 and/or within the processor 1602 during execution thereof by the computer system 1600, the main memory 1604 and the processor 1602 also constituting machine-readable media 1622. The instructions 1624 may also reside, completely or at least partially, within the static memory 1606.

While the machine-readable medium 1622 is shown in an example embodiment to be a single medium, the term “machine-readable medium” may include a single medium or multiple media (e.g., a centralized or distributed database, and/or associated caches and servers 110) that store the one or more instructions 1624 or data structures. The term “machine-readable medium” shall also be taken to include any tangible medium that is capable of storing, encoding or carrying instructions 1624 for execution by the machine and that cause the machine to perform any one or more of the methodologies of the present embodiments, or that is capable of storing, encoding or carrying data structures utilized by or associated with such instructions 1624. The term “machine-readable medium” shall accordingly be taken to include, but not be limited to, solid-state memories, and optical and magnetic media. Specific examples of machine-readable media 1622 include non-volatile memory, including by way of example semiconductor memory devices (e.g., erasable programmable read-only memory (EPROM), electrically erasable programmable read-only memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

### Transmission Medium

The instructions 1624 may further be transmitted or received over a communications network 1626 using a transmission medium. The instructions 1624 may be transmitted using the network interface device 1620 and any one of a number of well-known transfer protocols (e.g., HTTP). Examples of communication networks 1626 include a LAN, a WAN, the Internet, mobile telephone networks, POTS networks, and wireless data networks (e.g., WiFi and WiMax networks). The term “transmission medium” shall be taken to include any intangible medium capable of storing, encoding, or carrying instructions 1624 for execution by the machine, and includes digital or analog communications signals or other intangible media to facilitate communication of such software.

Although an embodiment has been described with reference to specific example embodiments, it will be evident that various modifications and changes may be made to these embodiments without departing from the scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

The following enumerated embodiments describe various example embodiments of methods, machine-readable media, and systems (e.g., machines, devices, or other apparatus) discussed herein.

A first embodiment provides a device (e.g., an occlusion device) comprising:

a camera configured to capture an image of a physical object;
a display;
a processor comprising an augmented reality (AR) occlusion application configured to:

identify the physical object based on the image of the physical object;

determine that the physical object includes confidential content based on an identification of the physical object; and

display an AR content in the display in response to determining that the physical object includes the confidential content, the AR content configured to occlude only the confidential content.

A second embodiment provides a device according to the first embodiment, wherein the processor is further configured to:
determine a confidentiality level of the confidential content;
generate an occlusion configuration based on the confidentiality level of the confidential content; and
   generate the AR content based on the occlusion configuration.

A third embodiment provides a device according to the first embodiment, wherein the processor is further configured to:

identify a user of the device;
determine a permission level associated with an identification of the user;
determine a confidentiality level of the confidential content;
generate an occlusion configuration based on the confidentiality level of the confidential content exceeding the permission level of the user; and
generate the AR content based on the occlusion configuration, the AR content configured to occlude the physical object to the user.

A fourth embodiment provides a device according to the first embodiment, wherein the processor is further configured to:

identify a user of the device;
determine a permission level associated with an identification of the user;
determine a confidentiality level of the confidential content;
generate an occlusion configuration based on the confidentiality level and the permission level, the occlusion configuration identifying a portion of the physical object to be occluded to the user; and
generate the AR content based on the occlusion configuration, the AR content configured to occlude only the confidential content to the user.

A fifth embodiment provides a device according to the first embodiment, wherein the processor is further configured to:

identify a user of the device;
determine a permission level associated with an identification of the user;
determine that the confidential content includes a document;
determine a confidentiality level associated with the document;
generate an occlusion configuration based on the confidentiality level and the permission level, the occlusion configuration identifying a portion of the document to be occluded to the user; and
generate the AR content based on the occlusion configuration, the AR content occluding only the portion of the document to the user.

A sixth embodiment provides a device according to the first embodiment, wherein the processor is further configured to:

identify a user of the device;
determine a permission level associated with an identification of the user; and
generate a replacement content consistent with the permission level of the user, the AR content including the replacement content, the replacement content configured to occlude and replace the confidential content.

A seventh embodiment provides a device according to the first embodiment, wherein the AR content includes a notification of the confidential content to a user of the device.

An eight embodiment provides a device according to the first embodiment, wherein the AR content includes a portion of an image of a background of the physical object.

A ninth embodiment provides a device according to the first embodiment, wherein the AR occlusion application is further configured to:

detect a removal of the display from a line of sight between an eye of the user and the confidential content; and
generate a notification message to a server in response to detecting the removal, the notification message identifying the user and the confidential content.

A tenth embodiment provides a device according to the first embodiment, further comprising:

a first set of sensors configured to generate user-based sensor data related to a user of the device; and
a second set of sensors configured to generate ambient-based sensor data related to the device,
wherein the AR occlusion application is configured to:
determine a user-based context based on the user-based sensor data, and an ambient-based context based on the ambient-based sensor data;
generate an occlusion configuration based on the user-based context and the ambient-based context; and
generate the AR content based on the occlusion configuration.

What is claimed is:

1. A device comprising:
a camera configured to capture an image of a physical object;
a display;
a processor comprising an augmented reality (AR) occlusion application configured to:
identify the physical object based on the image of the physical object;
determine that the physical object includes confidential content based on an identification of the physical object; and
display an AR content in the display in response to determining that the physical object includes the confidential content, the AR content configured to occlude only the confidential content.

2. The device of claim 1, wherein the AR occlusion application is further configured to:
determine a confidentiality level of the confidential content;
generate an occlusion configuration based on the confidentiality level of the confidential content; and
generate the AR content based on the occlusion configuration.

3. The device of claim 1, wherein the AR occlusion application is further configured to:
identify a user of the device;
determine a permission level associated with an identification of the user;
determine a confidentiality level of the confidential content;
generate an occlusion configuration based on the confidentiality level of the confidential content exceeding the permission level of the user; and
generate the AR content based on the occlusion configuration, the AR content configured to occlude the physical object to the user.

4. The device of claim 1, wherein the AR occlusion application is further configured to:
identify a user of the device;
determine a permission level associated with an identification of the user;
determine a confidentiality level of the confidential content;
generate an occlusion configuration based on the confidentiality level and the permission level, the occlusion configuration identifying a portion of the physical object to be occluded to the user;
generate the AR content based on the occlusion configuration, the AR content configured to occlude only the confidential content to the user.

5. The device of claim 1, wherein the AR occlusion application is further configured to:
identify a user of the device;
determine a permission level associated with an identification of the user;
determine that the confidential content includes a document;
determine a confidentiality level associated with the document;
generate an occlusion configuration based on the confidentiality level and the permission level, the occlusion configuration identifying a portion of the document to be occluded to the user; and
generate the AR content based on the occlusion configuration, the AR content occluding only the portion of the document to the user.

6. The device of claim 1, wherein the AR occlusion application is further configured to:
identify a user of the device;
determine a permission level associated with an identification of the user; and
generate a replacement content consistent with the permission level of the user, the AR content including the replacement content, the replacement content configured to occlude and replace the confidential content.

7. The device of claim 1, wherein the AR content includes a notification of the confidential content to a user of the device.

8. The device of claim 1, wherein the AR content includes a portion of an image of a background of the physical object.

9. The device of claim 1, wherein the AR occlusion application is further configured to:
detect a removal of the display from a line of sight between an eye of the user and the confidential content; and
generate a notification message to a server in response to detecting the removal, the notification message identifying the user and the confidential content.

10. The device of claim 1, further comprising:
a first set of sensors configured to generate user-based sensor data related to a user of the device; and
a second set of sensors configured to generate ambient-based sensor data related to the device,
wherein the AR occlusion application is configured to:
determine a user-based context based on the user-based sensor data, and an ambient-based context based on the ambient-based sensor data;
generate an occlusion configuration based on the user-based context and the ambient-based context; and
generate the AR content based on the occlusion configuration.

11. A method comprising:
capturing an image of a physical object with a camera of a device;
identifying, using a hardware processor of the device, the physical object based on the image of the physical object;
determining, using the hardware processor, that the physical object includes confidential content based on an identification of the physical object; and
displaying an AR content in a display of the device in response to determining that the physical object includes the confidential content, the AR content configured to occlude only the confidential content.

12. The method of claim 11, further comprising:
determining a confidentiality level of the confidential content;
generating an occlusion configuration based on the confidentiality level of the confidential content; and
generating the AR content based on the occlusion configuration.

13. The method of claim 11, further comprising:
identifying a user of the device;
determining a permission level associated with an identification of the user;
determining a confidentiality level of the confidential content;
generating an occlusion configuration based on the confidentiality level of the confidential content exceeding the permission level of the user; and
generating the AR content based on the occlusion configuration, the AR content configured to occlude the physical object to the user.

14. The method of claim 11, further comprising:
identifying a user of the device;
determining a permission level associated with an identification of the user;
determining a confidentiality level of the confidential content;
generating an occlusion configuration based on the confidentiality level and the permission level, the occlusion configuration identifying a portion of the physical object to be occluded to the user; and
generating the AR content based on the occlusion configuration, the AR content configured to occlude only the confidential content to the user.

15. The method of claim 11, further comprising:
identifying a user of the device;
determining a permission level associated with an identification of the user;
determining that the confidential content includes a document;
determining a confidentiality level associated with the document;
generating an occlusion configuration based on the confidentiality level and the permission level, the occlusion configuration identifying a portion of the document to be occluded to the user; and
generating the AR content based on the occlusion configuration, the AR content configured to occlude only the portion of the document to the user.

16. The method of claim 11, further comprising:
identifying a user of the device;
determining a permission level associated with an identification of the user; and
generating a replacement content consistent with the permission level of the user, the AR content including the replacement content, the replacement content configured to occlude and replace the confidential content.

17. The method of claim 11, wherein the AR content includes a notification of the confidential content to a user of the device or a portion of an image of a background of the physical object.

18. The method of claim 11, further comprising:
detecting a removal of the display from a line of sight between an eye of the user and the confidential content; and
generating a notification message to a server in response to detecting the removal, the notification message identifying the user and the confidential content.

19. The method of claim 11, further comprising:
generating user-based sensor data related to a user of the device; and
generating ambient-based sensor data related to the device,
determining a user-based context based on the user-based sensor data, and an ambient-based context based on the ambient-based sensor data;
generating an occlusion configuration based on the user-based context and the ambient-based context; and
generating the AR content based on the occlusion configuration.

20. A non-transitory machine-readable medium comprising instructions that, when executed by one or more processors of a machine, cause the machine to perform operations comprising:
capturing an image of a physical object with a camera of a device;
identifying the physical object based on the image of the physical object;
determining that the physical object includes confidential content based on an identification of the physical object; and
displaying an AR content in a display of the device in response to determining that the physical object includes the confidential content, the AR content configured to occlude only the confidential content.
